(19) United States
(12) Patent Application Publication
(10) Pub. No.: US 2026/0084465 A1
(43) Pub. Date: Mar. 26, 2026

(54) VEHICLE TIRE

(71) Applicant: Continental Reifen Deutschland GmbH, Hannover (DE)

(72) Inventors: Oliver Woidtke, Langenhagen (DE); Torsten Heinhaupt, Celle (DE); Klaus Wiese, Hannover (DE); Martin Vennebörger, Hannover (DE); Willem Tomforde, Springe (DE)

(73) Assignee: Continental Reifen Deutschland GmbH, Hannover (DE)

(21) Appl. No.: 19/109,082

(22) PCT Filed: Aug. 18, 2023
(86) PCT No.: PCT/DE2023/200171

§ 371 Date: Mar. 5, 2025

(30) Foreign Application Priority Data
Sep. 6, 2022 (DE) 10 2022 209 271.6

(51) Int. Cl. B60C 11/03; B60C 11/13

(52) U.S. Cl. CPC B60C 11/0306; B60C 11/1392

(57) ABSTRACT

Vehicle tire having a tread, comprising at least one profile block, wherein a profile block contour of the profile block comprises a contact side contour, an edge region contour, a bevel contour and a flank contour, wherein the contact side contour adjoins the edge region contour, wherein the edge region contour adjoins the bevel contour and wherein the bevel contour adjoins the flank contour, wherein the contact side contour runs substantially in a base area of the tread, wherein at least one point on the edge region contour lies above the base area by an edge region height. The profile block contour follows a convex profile between a first point on the flank contour and a second point, situated below the base area on the bevel contour.

### CROSS-REFERENCE TO RELATED APPLICATIONS

The present application is a National Stage Application under 35 U.S.C. § 371 of International Patent Application No. PCT/DE2023/200171 filed on Aug. 18, 2023, and claims priority from German Patent Application No 10 2022 209 271.6 Filed on September 6, 2022., in the German Patent and Trademark Office, the disclosures of which are herein incorporated by reference in their entireties.

### BRIEF SUMMARY

The invention relates to a vehicle tire having a tread, wherein the tread comprises at least one profile block. A profile block contour of the profile block comprises a contact side contour, an edge region contour, a bevel contour and a flank contour, wherein the contact side contour adjoins the edge region contour, wherein the edge region contour adjoins the bevel contour, and wherein the bevel contour adjoins the flank contour. The contact side contour runs substantially in a base area of the tread, wherein at least one point on the edge region contour lies above the base area by an edge region height.

Profile blocks on the treads of vehicle tires have specific contours which can have an influence on different properties of the vehicle tires. On the one hand, for example, bevels are provided on the block edges of profile blocks in order to increase traction on snow. Bevels can furthermore also improve the adhesion properties on wet and dry roads under braking conditions. Alternatively, the profile blocks are provided with radially projecting edge regions which, as snow edges, can achieve a milling effect and improve the traction on snow. Radially projecting edge regions or ribs can moreover contribute to reducing pass-by noise.

DE 10 2015 223 535 A1 describes pneumatic vehicle tires having profile blocks, wherein each profile block is adjoined in the circumferential direction by a groove in each case, and wherein ribs are formed on the profile blocks, which ribs extend adjacent to a groove portion and, with respect to a respective profile block surface, each have a height of 0.2 mm to 0.5 mm in the radial direction and a width of 0.7 mm to 1.9 mm at their base.

Some contour properties of profile blocks may also have a negative effect on the properties of vehicle tires or cause negative side effects. Bevels may have a negative effect, for example, on the pass-by noise. Snow edges may have a negative effect on the dry braking properties. Previously, therefore, the improvements which can be achieved by a specific contour property in one region have often had to be weighed against the associated impairments in another region.

The invention addresses the problem of optimizing the snow traction properties of a vehicle tire without accepting any impairment in the braking properties on wet and dry roads and without adversely affecting the pass-by noise.

The stated object is achieved according to the invention in that the profile block contour follows a convex profile between a first point on the flank contour and a second point, situated below the base area, on the bevel contour.

The invention is based firstly on the concept that a combination of the bevel contour according to the invention with the edge region contour according to the invention enables the positive snow traction properties of a bevel and a snow edge to be combined. Furthermore, the invention recognizes that the undesired side effects of a bevel or snow edge respectively on their own can be alleviated, neutralized or even overcompensated for by the positive effects of the respectively other contour property. In particular, the disadvantageous dry braking properties associated with the edge region contour according to the invention and in particular with a snow edge can be counteracted by the advantageous braking properties associated with the bevel contour according to the invention. On the other hand, the disadvantageous effects, which are associated with the bevel contour according to the invention, on the pass-by noise can be counteracted by advantageous effects, which are associated with the edge region contour according to the invention, on the pass-by noise.

If the directional designations of axially, in the axial direction, radially, in the radial direction and in the circumferential direction are used, they refer to the vehicle tire, attached as intended to a vehicle, and to its rolling movement carried out thereon. Here, the radial direction refers to a direction perpendicular to the axis of rotation of the vehicle tire and intersecting the axis of rotation. Inward in the radial direction refers to the orientation which faces the axis of rotation in the radial direction. Outward in the radial direction refers to the orientation which faces away from the axis of rotation in the radial direction. The circumferential direction denotes the direction of a rolling movement about the axis of rotation. When the vehicle is traveling forward, during a 360° revolution of the vehicle tire, a front position in the circumferential direction on the vehicle tire passes earlier through a minimum distance from the road surface than a rear position in the circumferential direction, the rear position in the circumferential direction passing through its minimum distance from the road surface by less than 180° behind the front position. The axial direction refers to a direction parallel to the axis of rotation. In this case, pointing axially inward refers to an orientation which faces axially toward a tire equatorial plane or a tire equatorial line. The tire equatorial plane is a plane which is perpendicular to the axis of rotation of the vehicle tire and runs through the center of the axial width of the vehicle tire, the tire equatorial line running in the tire equatorial plane and on the surface of the vehicle tire.

The base area of the tread coincides with that macroscopically smooth surface which the tread would have if no negative and no positive profile elements of any kind, such as grooves or projections, were provided on the tread. Specifically, the base area is physically obtained in the tread wherever no such profile elements are provided. The obtained portions of the base area may be at least partially intended for contact with a road surface. Wherever, for example, a groove runs through the tread, the base area continues to run as an imaginary area above the groove; wherever, for example, a projection is arranged on the tread, the base area continues to run as an imaginary area below the projection.

The contact side contour can then be referred to as running substantially in the base area if running by more than 50% of its length in the base area. The contact side contour may be penetrated, for example, by sipes and/or projections on the tread, or may run locally through the sipes and/or beyond the projections.

Microscopic roughnesses may occur on the base area or on areas of the profile block, for example, on a contact side, an edge region, a flank or a bevel, which microscopic roughnesses within the scope of a production process can be embossed on the tire by a mold and/or produced by aftertreatment of a heated tire. Such roughnesses are characterized by an amplitude of less than 50 um and can influence the frictional properties of the rough area on different surfaces or with different contact partners. The roughnesses are disregarded for the present description of an invention, but may be combined with the teaching according to the invention.

A point on the edge region contour then lies above the base area by an edge region height when the point, as measured perpendicular to the base area imaginarily running under the point, is spaced apart from the base area by an edge region height. A point lies below the base area when the point, as measured perpendicular to the base area imaginarily running above the point, is spaced apart from the base area. When the base area is curved, the distance is measured along a normal vector on the base area.

Alternatively, the tread can be considered in an unwound state and can thus be used as a basis for distance measurements and, for example, for direction measurements. In the unwound state, the tread is unwound or unfolded from the vehicle tire in the circumferential direction and in the axial or radial direction in such a way that the base area lies in a flat plane.

The profile block contour then follows a convex profile between a first point on the flank contour and a second point, situated below the base area, on the bevel contour, if the profile block contour between the two points lies exclusively on an outer side of a straight connecting section running between the two points, the outer side being situated in the direction of the surface of the profile block. The connecting line may have a curved profile and/or comprise one or more edges. Preferably, the convex profile, as measured perpendicular to the straight connecting section between the first point and the second point, is spaced apart at least by up to 0.3 mm, preferably between 0.5 mm and 1 mm from the straight connecting section.

The contact side contour, the edge region contour, the bevel contour and the flank contour can merge continuously into one another in pairs and can also merge continuously into one another in pairs in a first derivative and higher derivatives. Alternatively, the contact side contour, the edge region contour, the bevel contour and the flank contour can merge into one another in pairs at defined angles. It should be noted here that angles in a profile of a vehicle tire are usually rounded with a certain transition radius within the scope of manufacturing tolerances.

An embodiment, wherein, in the unwound state of the tread, the contact side contour runs substantially along a first straight line, wherein the bevel contour runs substantially along a second straight line, and wherein the second straight line is rotated by a bevel angle with respect to the first straight line, is particularly preferred. Furthermore, in the unwound state of the tread, the flank contour can run substantially along a third straight line, wherein the third straight line can be rotated by a flank angle with respect to the first straight line. In particular, the bevel angle is preferably smaller than the flank angle. In the unwound state of the tread, a first portion of the edge region contour adjoining the bevel contour can moreover run substantially along an additional straight line, wherein the additional straight line can be rotated by an edge region angle with respect to the first straight line.

The rotation of the second straight line with respect to the first straight line by the bevel angle can take place in a first direction of rotation. The rotation of the third straight line with respect to the first straight line by the flank angle can also take place in the first direction of rotation. The rotation of the additional straight line with respect to the first straight line by the edge region angle can also take place in the first direction of rotation. The designations “first”, “second”, “third” and “additional” are exclusively used to identify the various straight lines and do not describe any particular orientations, arrangements and/or properties of the straight lines that go beyond or deviate from the expressly described orientations, arrangements and/or properties of the straight lines.

A contour which runs substantially along a specific straight line can be a straight line which is rotated only by a small angle, for example by less than 2°, with respect to the specific straight line. A contour which runs substantially along a specific straight line can have portions running in a deviating manner, but to a large extent, for example to an extent of more than 50% of its overall length, can run along the specific straight line with a deviation of less than 2°. The contact side contour preferably runs to an extent of more than 50% of its length along the first straight line. The bevel contour preferably runs to an extent of more than 50% of its length along the second straight line. The flank contour preferably runs to an extent of more than 50% of its length along the third straight line. The first portion of the edge region contour preferably runs to an extent of more than 50% of its length along the additional straight line.

The profile block comprises a profile block surface. The profile block contour is one-dimensional and runs on the profile block surface. Furthermore, the profile block contour runs perpendicular to a profile block contour vector and in an imaginary profile block contour plane, the profile block contour vector being a normal vector on the profile block contour plane. The profile block contour vector preferably does not have a component in the radial direction. In other words, the profile block contour plane preferably includes the radial direction. The profile block contour vector can point predominantly in the axial direction or predominantly in the circumferential direction, for example. A vector pointing predominantly in a particular direction includes an angle of less than 45° with the particular direction. A plane facing predominantly in a particular direction has the vector pointing predominantly in the particular direction as a normal vector.

The profile block surface can comprise a contact side, an edge region, a bevel and a flank, wherein the contact side contour runs on the contact side, the edge region contour runs on the edge region, the bevel contour runs on the bevel, and the flank contour runs on the flank.

In particular, a normal vector can point outward substantially in the radial direction on the contact side; in the unwound state of the tread, the contact side lies substantially on the base area. The contact side can be configured to come into direct contact with a road surface during operation of the vehicle tire.

The profile block has a width extent. The width extent is one-dimensional and runs on the profile block surface. The width extent can run along one or more straight lines and/or can be curved. The width extent intersects the profile block contour at an intersection point. At the intersection point, the width extent runs at least partially perpendicular, preferably predominantly perpendicular and more preferably exactly perpendicular to the profile block contour. By way of example, if the width extent of the profile block at the intersection point runs predominantly in the axial direction, the profile block contour can run perpendicular to the axial direction or the profile block contour can run perpendicular to the width extent.

A profile block may comprise a plurality of profile block contours. A width extent of a profile block can be intersected at a plurality of different intersection points of profile block contours according to the invention. A portion of a width extent, which consists of intersection points, can span a portion of a profile block surface with a set of profile block contours. A contact side, an edge region, a bevel and a flank can be provided over the entire width extent of a profile block or only along part of the width extent. In one embodiment of the invention, the contact side, edge region, bevel and flank are provided wherever the width extent of a profile block runs predominantly in the axial direction. The profile block contours can assume different or identical shapes at different intersection points along the width extent.

The flank angle is preferably not substantially greater than 90°, in particular less than 95°; the flank angle can be between 60° and 90°, preferably between 77° and 90°. The bevel angle can be between 20° and 70°, preferably between 35° and 55°. The edge region angle is preferably not greater than 90°; in particular, the edge region angle can be between 20° and 90°, preferably between 45° and 90°. The bevel angle can be between 10° and 80°, preferably between 25° and 55°, smaller than the flank angle. The edge region angle can differ from the bevel angle; in particular, the edge region angle can be between 10° and 80°, preferably between 25° and 55°, greater than the bevel angle. The angle specifications preferably apply to profile block contours which run at the intersection point perpendicular to the width extent of the profile block.

The profile block can comprise a snow edge, wherein the edge region of the profile block surface and the surface of the snow edge may overlap. In particular, the edge region of the profile block surface and the surface of the snow edge can be identical, and therefore the edge region contour defines a contour of the snow edge.

The edge region height between the at least one point on the edge region contour and the base area may be between 0.1 mm and 1 mm, preferably between 0.2 mm and 0.5 mm. The edge region height can correspond to a protrusion of the snow edge above the contact side or above the base area.

In particular, the first portion of the edge region contour can run at least partially above the base area. Preferably, the first portion of the edge region contour runs predominantly above the base area. In particular, the contact side contour can adjoin the one end of the edge region contour at the same height as the bevel contour at the other end of the edge region contour such that the first portion of the edge region contour lies completely above the base area.

The edge region contour can comprise a second portion, wherein, in the unwound state of the tread, the second portion can run substantially parallel to the base area of the tread. The second portion can be between 0.2 mm and 2 mm, preferably between 0.3 mm and 1 mm in length. The length specifications preferably apply to profile block contours which run at the intersection point perpendicular to the width extent of the profile block.

The edge region contour can comprise a third portion, wherein the third portion can include an angle with a perpendicular on the base area. Alternatively, the third portion can extend substantially parallel to the perpendicular on the base area. The second portion can be adjacent to the first portion, wherein the third portion at a first end can be adjacent to the second portion and at a second end to the contact side contour.

The multiplicity of corners and angles in the edge region contour make it possible for the snow traction properties of the vehicle tire to be further improved. In particular, snow can settle in the tire profile in the region of the corners and angles, as a result of which a snow-snow grip can form between the vehicle tire and a snow-covered road surface.

A connecting straight line through the first point on the flank contour and a third point on the bevel contour can intersect the edge region contour at a fourth point. This may be the case, for example, if the convex curvature of the profile block contour reverses in a portion between the bevel contour and the edge region contour such that a connecting line between the third point and the fourth point is concave. The bevel contour can run completely below the base area, that is to say can be arranged entirely in a negative portion of the profile of the vehicle tire. The third point on the bevel contour can be identical to the second point on the bevel contour. This is possible in particular when the bevel contour runs completely below the base area.

In the unwound state of the tread, the bevel contour can extend between 0.5 mm and 3 mm parallel to the base area and between 0.5 mm and 4 mm perpendicular to the base area. Preferably, the bevel contour extends between 0.8 mm and 2 mm parallel to the base area and between 0.8 mm and 3 mm perpendicular to the base area. The length specifications preferably apply to profile block contours which at the intersection point run perpendicular to the width extent of the profile block.

The tread can comprise two profile blocks, wherein a groove may be arranged between the two profile blocks. A one-dimensional groove contour can run on a surface of the groove, wherein the groove contour can lie in the same imaginary plane as the profile block contour and can adjoin the flank contour.

In particular, the tread can comprise a plurality of profile blocks, wherein a plurality of grooves can run between the profile blocks, and wherein the grooves can comprise, for example, grooves running predominantly in the circumferential direction and/or grooves running predominantly in the axial direction. In one embodiment of the invention, each groove can be adjoined by a profile block surface having a profile block contour according to the invention.

The profile block surface can comprise two flanks, two bevels and two edge regions, wherein the edge region contour of a first edge region and the edge region contour of a second edge region can adjoin the contact side contour opposite one another. Such an embodiment can be particularly advantageous in particular in the case of non-directional vehicle tires, specifically in particular when the profile block contour plane faces predominantly in the axial direction and the flanks, bevels and edge regions on opposite sides of the profile block are at least partially stressed in the circumferential direction during braking and accelerating. Alternatively, the profile block surface of a profile block can comprise only respectively one flank, one bevel and one edge region with a profile block contour according to the invention running thereon. In this case, the flank, the bevel and the edge region are preferably arranged on a braking edge of the vehicle tire.

### DESCRIPTION OF THE DRAWINGS

The invention will be described below by way of example with reference to the attached drawings on the basis of advantageous embodiments. In the drawings:

FIG. 1 schematically shows a perspective view of a vehicle tire having a tread and profile blocks,

FIG. 2 schematically shows the tread of the vehicle tire from FIG. 1 in an unwound state,

FIG. 3 schematically shows a perspective view of an embodiment of a profile block surface according to the invention,

FIG. 4a shows a profile block contour corresponding to a profile block surface according to FIG. 3,

FIG. 4b shows the profile block contour shown in FIG. 4a with alternative explanation signs,

FIG. 5 shows a profile block contour in the transition to a channel contour according to an alternative embodiment of the invention,

FIG. 6 shows a profile block contour with in each case two flank contours, bevel contours and edge region contours according to a further alternative embodiment of the invention,

FIG. 7 shows a perspective view of a tread with a plurality of profile blocks according to an embodiment of the invention.

### DETAILED DESCRIPTION

Vehicle tires designed according to the invention are tires of any type of construction, in particular radial tires, and tires of any type, in particular pneumatic vehicle tires for motor vehicles, such as passenger cars, light trucks or utility vehicles.

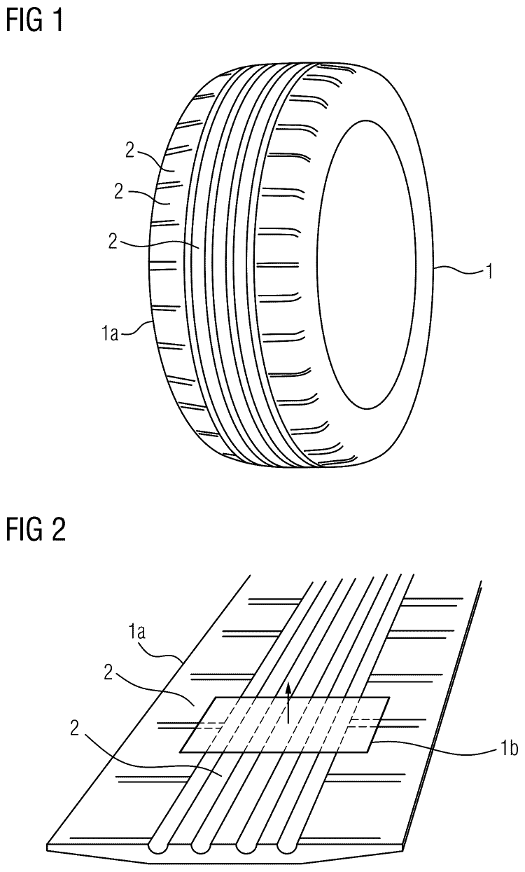

FIG. 1 schematically shows a vehicle tire 1 having a tread 1a and profile blocks 2. The pattern of the profile shown should be understood as a generic example of a profile pattern and does not necessarily have to be particularly suitable for combining with the teaching according to the invention. If the invention is intended to be used on the profile shown, the profile blocks 2 that are delimited from one another by transverse grooves in the tire shoulders and the encircling ribs 2 that are delimited from one another by circumferential grooves in the central region of the tread 1a can be configured as profile blocks 2 according to the invention. Alternatively, the teaching according to the invention can also be applied to any other desired profile geometries with correspondingly alternatively arranged profile blocks 2.

FIG. 2 shows the tread 1a of the vehicle tire 1 from FIG. 1 in an unwound state. In the unwound state, the tread 1a is unwound or unfolded from the vehicle tire in the circumferential direction and in the axial or radial direction in such a way that a surface of the tread 1a substantially coincides with a flat plane. If, in the example shown, no grooves were provided in the tread 1a, or if the grooves were completely filled with material and if the surface of the tread 1a were leveled in this way, the surface of the tread 1a would lie completely in a flat plane in the unwound state. An imaginary surface of a tread 1a, which would arise without any profile elements such as grooves or projections, is referred to as the base area 1b and, in the unwound state of the tread 1a, likewise lies in a flat plane, as shown in FIG. 2.

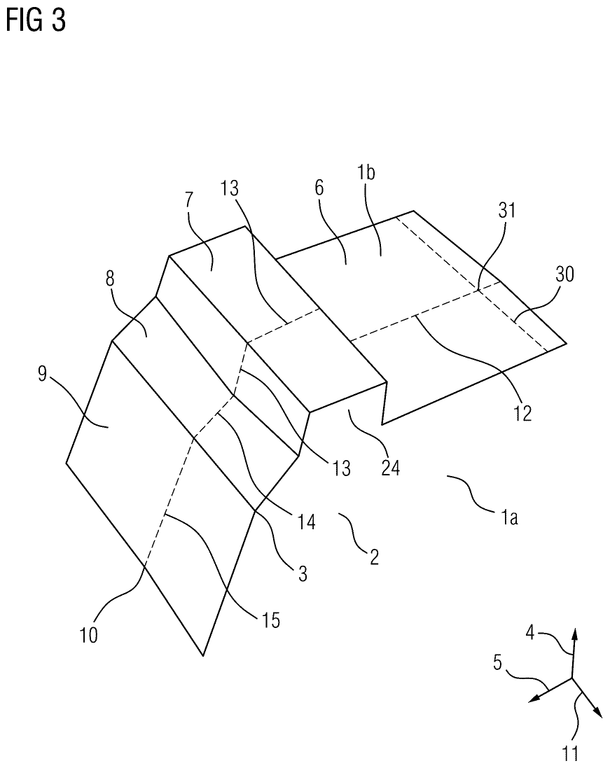

FIG. 3 shows a profile block surface 3 on an embodiment of a profile block 2 according to the invention with a flank 9, a bevel 8, an edge region 7 and a contact side 6. The contact side 6 faces outward in the radial direction 4 and lies in the base area 1b of the tread 1a. The flank 9, the bevel 8 and the edge region 7 face outward in the radial direction 4 and/or in the circumferential direction 5. The edge region 7 coincides with the surface of a snow edge 24 of the profile block 2. In other words, the edge region 7 according to the illustrated embodiment is identical to the surface of the snow edge 24. A profile block contour 10 runs perpendicular to the axial direction 11. The profile block contour 10 comprises a contact side contour 12, an edge region contour 13, a bevel contour 14 and a flank contour 15. The profile block surface 3 has a width extent 30 which runs parallel to the axial direction 11. The width extent 30 intersects the profile block contour 10 at a right angle at an intersection point 31.

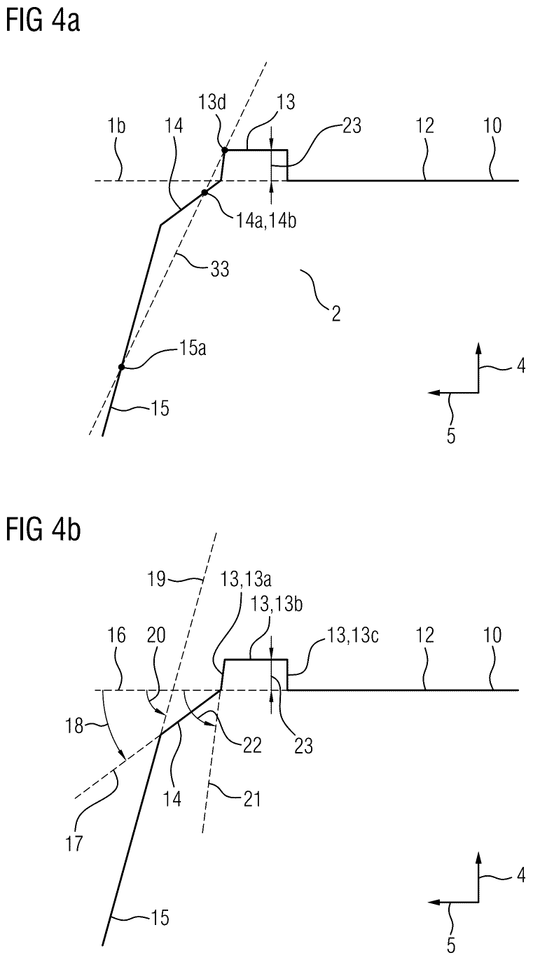

FIG. 4a shows the profile block contour 10 from FIG. 3, the drawing plane corresponding to the profile block contour plane. The contact side contour 12 adjoins the edge region contour 13, the edge region contour 13 adjoining the bevel contour 14 and the bevel contour 14 adjoining the flank contour 15. The contact side contour 12 runs in the base area 1b, the intersection of which with the drawing plane is illustrated as a dashed line in FIG. 4a. The edge region contour 13 runs at its maximum distance from the base area 1b in an edge region height 23 above the base area 1b. The profile block contour 10 follows a convex profile between a first point 15a on the flank contour 15 and a second point 14a, situated below the base area 1b, on the bevel contour 14. In other words, the flank contour 15 and the bevel contour between the first point 15a and the second point 14a are curved out of the profile block 2 in the circumferential direction 5 and radial direction 4 with respect to a straight connecting path between the two points 14a, 15a.

In the exemplary embodiment shown, a connecting straight line 33 through the first point 15a and a third point 14b intersects the edge region contour 13 at a fourth point 13d. A concave portion of the profile block contour 10 is produced here between the third point 14a on the bevel contour 14 and the fourth point 13d on the edge region contour 13. In the exemplary embodiment shown, the bevel contour 14 moreover runs completely below the base area 1b, and the second point 14a arranged below the base area 1b coincides with the third point 14b. Thus, in the exemplary embodiment shown, the straight connecting path between the first point 15a and the second point 14a lies on the connecting straight line 33 between the first point 15a and the third point 14b. The convex profile can be spaced apart at least by up to 0.3 mm, preferably between 0.5 mm and 1 mm, perpendicular to the straight connecting path—and in the exemplary embodiment shown also perpendicular to the connecting straight line 33.

The convex and/or concave profiles of the profile block contour may also be rounded instead of the angled formation shown in FIG. 4a. In a preferred embodiment, however, the individual contour regions run at least partially along straight lines, as will be described even more clearly below on the basis of FIG. 4b.

FIG. 4b shows the profile block contour 10 from FIG. 4a, but with different auxiliary lines and reference signs. Accordingly, the contact side contour 12 runs along a first straight line 16, the first straight line 16 running parallel to the circumferential direction 5. The bevel contour 14 runs along a second straight line 17, the second straight line 17 being rotated with respect to the first straight line 16 by a bevel angle 18. The flank contour 15 runs along a third straight line 19, the third straight line 19 being rotated with respect to the first straight line 16 by a flank angle 20. In the illustrated embodiment, the bevel angle 18 is smaller than the flank angle 20. A first portion 13a of the edge region contour 13 adjoining the bevel contour 14 runs along an additional straight line 21, the additional straight line 21 being rotated with respect to the first straight line 16 by an edge region angle 22. The edge region angle 22 differs from the bevel angle 18, and therefore an additional angle is produced between the first portion 13a and the bevel contour 14.

The edge region contour 13 comprises a second portion 13b, the second portion 13b running parallel to the circumferential direction 5. Furthermore, the edge region contour 13 comprises a third portion 13c, the third portion 13c running parallel to the radial direction 4. According to the exemplary embodiment illustrated in FIG. 3, the second portion 13b adjoins the first portion 13a, the third portion 13c adjoining the second portion 13b and the contact side contour 12. In the radial direction 4, the contact side contour 12 adjoins the edge region contour 13 at the same height as the edge region contour 13 adjoins the bevel contour 14. According to the illustrated embodiment, the transition between the contact side contour 12 and the third portion 13c on one side and the transition between the bevel contour 14 and the first portion 13a on the other side are thus arranged radially at the same height as the contact side contour 12. Furthermore, according to the illustrated embodiment, the first portion 13a of the edge region contour 13 runs completely above the contact side contour 12 in the radial direction 4, and the second portion 13b lies radially above the contact side contour 12 by an edge region height 23.

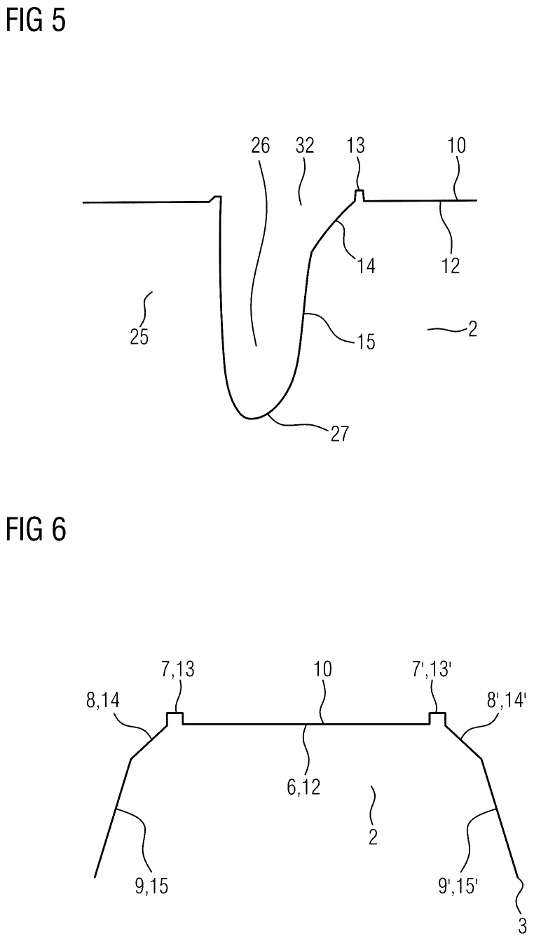

FIG. 5 shows an alternative embodiment of a profile block contour 10 with a contact side contour 12, an edge region contour 13, a bevel contour 14 and a flank contour 15. Arranged adjacent to the first profile block 2 is a groove 26 which separates the first profile block 2 from a second profile block 25. In the exemplary embodiment shown, the groove 26 runs perpendicular to the drawing plane of FIG. 5. A groove contour 27 which adjoins the flank contour 15 of the profile block contour 10 runs on a surface of the groove 26. According to FIG. 5, a profile block contour 10 according to the invention is provided only on the first profile block 2, but not on the second profile block 25 on the opposite side of the groove 26. The exemplary embodiment illustrated preferably relates to the profile blocks 2, 25 of a directional profile; in this case, the braking properties can already be noticeably improved if the profile block contour according to the invention is provided only at the braking edges 32.

FIG. 6 shows a further alternative embodiment of a profile block contour 10. Here, in each case one flank 9, 9′, in each case one bevel 8, 8′ and in each case one edge region 7, 7′ are arranged on the profile block surface 3 on either side of the profile block 2, the edge regions 7, 7′ adjoining the contact side 6 opposite one another. Accordingly, the profile block contour 10 illustrated in FIG. 6 comprises two flank contours 15, 15′, two bevel contours 14, 14′ and two edge regions 13, 13′, the edge regions 14, 14′ adjoining the contact side contour 12 at opposite ends. The embodiment shown is suitable in particular for non-directional profiles.

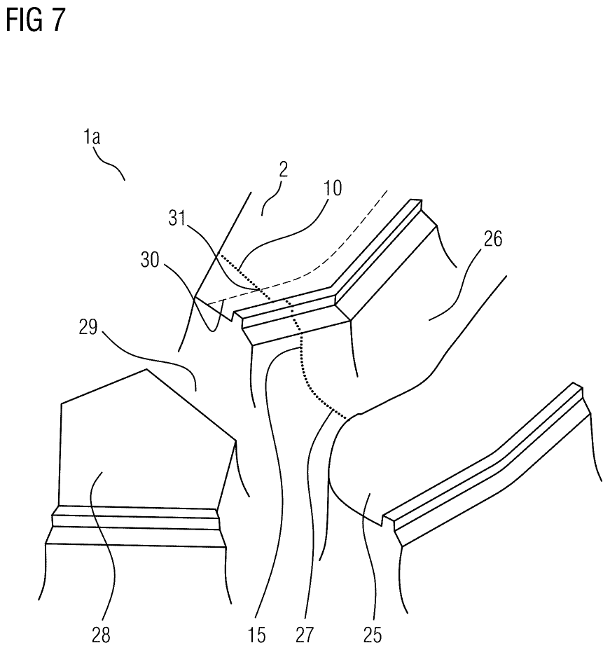

FIG. 7 schematically shows a perspective view of a tread 1a having a plurality of profile blocks 2, 25, 28 according to a further alternative embodiment of the invention. Grooves 26, 29 run between the profile blocks 2, 25, 28. The flank contour 15 of a profile block contour 10 adjoins a groove contour 27 of the groove 26. In the exemplary embodiment illustrated, the groove contour 27 and the profile block contour 10 run perpendicular to a width extent 30 of the profile block 2 at an intersection point 31.

1. A vehicle tire having a tread, comprising at least one profile block, wherein a profile block contour of the profile block comprises a contact side contour an edge region contour, a bevel contour and a flank contour, wherein the contact side contour adjoins the edge region contour, wherein the edge region contour adjoins the bevel contour, and wherein the bevel contour adjoins the flank contour, wherein the contact side contour runs substantially in a base area of the tread, wherein at least one point on the edge region contour lies above the base area by an edge region height,
wherein the profile block contour follows a convex profile between a first point on the flank contour and a second point, situated below the base area, on the bevel contour.

2. The vehicle tire as claimed in claim 1, wherein, in an unwound state of the tread, the contact side contour runs substantially along a first straight line, wherein the bevel contour runs substantially along a second straight line, wherein the second straight line is rotated by a bevel angle with respect to the first straight line, wherein the bevel angle is preferably between 20° and 70°.

3. The vehicle tire as claimed in claim 2, wherein the flank contour runs substantially along a third straight line, wherein the third straight line is rotated by a flank angle with respect to the first straight line, wherein the flank angle is less than 95°.

4. The vehicle tire as claimed in claim 3, wherein the bevel angle is smaller than the flank angle and is between 10° and 80° smaller than the flank angle.

5. The vehicle tire of claim 4, wherein a first portion of the edge region contour adjoining the bevel contour runs substantially along an additional straight line, wherein the additional straight line is rotated by an edge region angle with respect to the first straight line, and wherein the edge region angle differs from the bevel angle.

6. The vehicle tire as claimed in claim 5, wherein the edge region angle is not greater than 90° and is between 20° and 90°.

7. The vehicle of claim 6, wherein the edge region angle is between 10° and 80° larger than the bevel angle.

8. The vehicle tire of claim 7 in that the first portion of the edge region contour runs at least partially above the base area.

9. The vehicle tire as claimed in claim 8, wherein the bevel contour runs completely below the base area.

10. The vehicle tire claim 1, wherein a connecting straight line through the first point on the flank contour and a third point on the bevel contour intersects the edge region contour at a fourth point.

11. The vehicle tire as claimed in claim 10, wherein the third point coincides with the second point.

12. The vehicle tire of claim 1, wherein the convex profile is spaced apart at least by up to 0.3 mm perpendicular to a straight connecting section between the first point and the second point.

13. The vehicle tire claim 1, wherein, in an unwound state of the tread, the bevel contour extends between 0.5 mm and 3 mm parallel to the base area and between 0.5 mm and 4 mm perpendicular to the base area, wherein the bevel contour extends between 0.8 mm and 2 mm parallel to the base area and between 0.8 mm and 3 mm perpendicular to the base area.

14. The vehicle tire of claim 1, wherein the edge region height is between 0.1 mm and 1 mm, preferably between 0.2 mm and 0.5 mm.

15. The vehicle tire of claim 1, in that the edge region contour comprises a second portion, wherein, in an unwound state of the tread, the second portion runs substantially parallel to the base area of the tread, wherein the second portion is between 0.2 mm and 2 mm, preferably between 0.3 mm and 1 mm in length.

16. A vehicle tire comprising:
a tread having a profile block;
a profile block contour of the profile block comprises a contact side contour, an edge region contour, a bevel contour and a flank contour;
the contact side contour adjoins the edge region contour;
the edge region contour adjoins the bevel contour;
the bevel contour adjoins the flank contour;
the contact side contour runs substantially in a base area of the tread;
at least one point on the edge region contour lies above the base area by an edge region height;
wherein the profile block contour follows a convex profile between a first point on the flank contour and a second point, situated below the base area, on the bevel contour;
in an unwound state of the tread, the contact side contour runs substantially along a first straight line, wherein the bevel contour runs substantially along a second straight line, wherein the second straight line is rotated by a bevel angle with respect to the first straight line, wherein the bevel angle is between 20° and 70°;
the flank contour runs substantially along a third straight line rotated by a flank angle with respect to the first straight line, wherein the flank angle is less than 95°;
the bevel angle is between 10° and 80° smaller than the flank angle;
a first portion of the edge region contour adjoining the bevel contour runs substantially along an additional straight line;
the additional straight line is rotated by an edge region angle with respect to the first straight line; and
the edge region angle differs from the bevel angle.
